(19) United States
(12) Patent Application Publication
(10) Pub. No.: US 2013/0264806 A1
(43) Pub. Date: Oct. 10, 2013

(54) Portable Power Device

(71) Applicant: Shirley Collins, Spartanburg, SC (US)

(72) Inventor: Shirley Collins, Spartanburg, SC (US)

(21) Appl. No.: 13/858,365

(22) Filed: Apr. 8, 2013

Related U.S. Application Data
(60) Provisional application No. 61/622,028, filed on Apr. 10, 2012.

(51) Int. Cl. B60S 9/04

(52) U.S. Cl. CPC B60S 9/04
USPC 280/766.1

(57) ABSTRACT

A portable power device for powering an existing crankshaft operated semi trailer landing gear is disclosed. The portable power device comprises a motor for rotating a drive shaft with an engaging end. An opening in the drive shaft fits over the engaging end for mating with the existing crankshaft once a hand crank is removed. The portable power device further comprises a plurality of sockets for engaging a lug nut.

### CROSS-REFERENCE

This application claims priority from Provisional Patent Application Ser. No. 61/622,028 filed Apr. 10, 2012.

### FIELD OF THE INVENTION

This invention pertains generally to an electrically operated portable power device for raising and lowering a tractor trailer's landing gear, and more particularly to a portable battery powered unit for attaching to and operating a tractor trailer's landing gear in lieu of a hand crank and/or rotating a lug nut.

### BACKGROUND

Semi trailer truck landing gear generally comprise height adjustable legs that support one end of a trailer when uncoupled from a truck cab. When in motion, the landing gear is retracted by operating a jack mechanism. When the trailer is unhitched, the landing gear is extended by the jack so that the trailer is lifted up off of the cab. The cab may then be driven away leaving the trailer supported by the landing gear on one end and the rear tires on the other end. In order to raise and lower landing gear on a tractor trailer truck, an individual traditionally operates a hand crank which may lead to back strain or injury. Operating the hand crank may be difficult for older truck drivers or those with back problems. As trailers are frequently uncoupled several times throughout the day, the hand crank is extremely inefficient.

Consequently, there exists a need for a more efficient and safer tool designed to raise and lower trailer landing gear. The present invention discloses a device for powering an existing hand crank operated semi trailer landing gear without the need for manual labor. The device allows a user to easily operate the crank shaft of existing landing gear without the need to operate the crank by hand. The portable power device allows a user to raise and lower the trailer by removing the hand crank and operating the crankshaft with a motor instead of by hand. Additionally, the device is adaptable for use in loosening and/or tightening a lug nut from an automobile tire.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a portable power device for powering an existing hand crank operated semi trailer landing gear. The portable power device comprises a housing encasing a battery operated motor that rotates a drive shaft. The drive shaft extends from the motor through the housing and comprises at least one engaging element for engaging a rotatable element on the existing hand crank operated semi trailer landing gear once a hand crank is removed from the existing hand crank operated semi trailer landing gear.

Furthermore, in a preferred embodiment, the at least one engaging element comprises at least one socket, attachable to the drive shaft. The at least one socket engages a male drive end on the crankshaft for operating the semi trailer landing gear once the hand crank is removed and is held in place on the crankshaft with a securing pin to prevent slippage. Once in place, the portable power device can raise and/or lower the semi trailer landing gear without the need to manually operate the hand crank. The battery is rechargeable with a traditional power cord or with a vehicle adaptor power cord for use with a vehicle battery. Additionally, the portable power device is usable to rotate a lug nut when changing a vehicle tire in place of a manually operated lug nut wrench.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of a prior art semi tractor trailer and a landing gear.

FIG. 2 illustrates a perspective view of the portable power device in a nonuse position in accordance with the disclosed architecture.

FIG. 3 illustrates a perspective view of the portable power device operating a semi trailer landing gear in accordance with the disclosed architecture.

FIG. 4 illustrates a perspective view of the portable power device removing a lug nut from an automobile tire in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter. The invention relates generally to a portable power device for operating a landing jack for a semi tractor trailer.

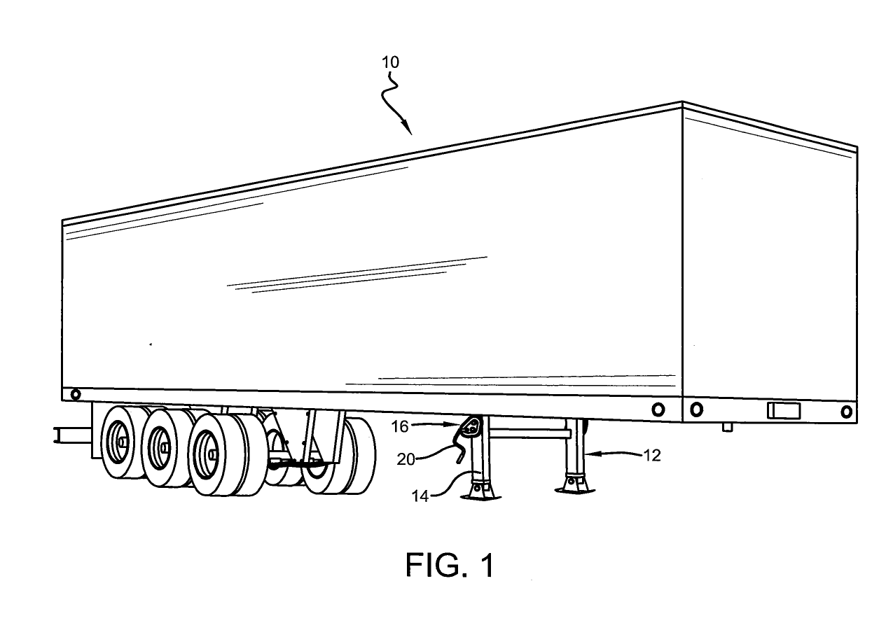

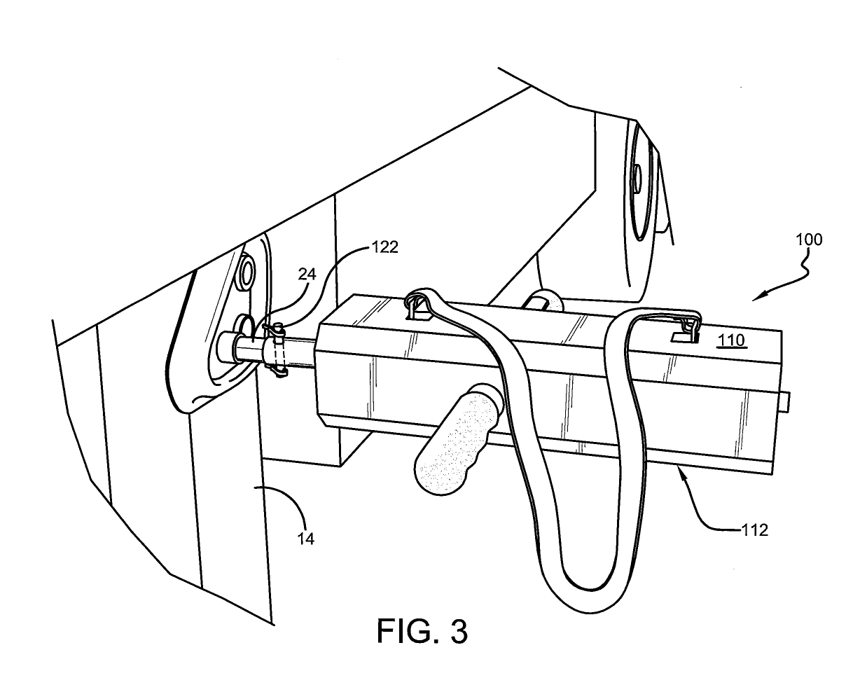

Referring initially to the drawings, FIGS. 1 and 3 illustrates a prior art semi tractor trailer 10 with a lifting apparatus 12. The lifting apparatus 12 is typically a landing gear 14 operable with a hand powered jack mechanism 16. The hand powered jack mechanism 16 generally includes a crankshaft having a rotatable element operable with a hand crank 20. The crankshaft is operable by attaching the hand crank 20 to a male drive end 24 of the rotatable element of the crankshaft. The landing gear 14 is then able to be raised and lowered by rotating the hand crank 20 either clockwise or counterclockwise.

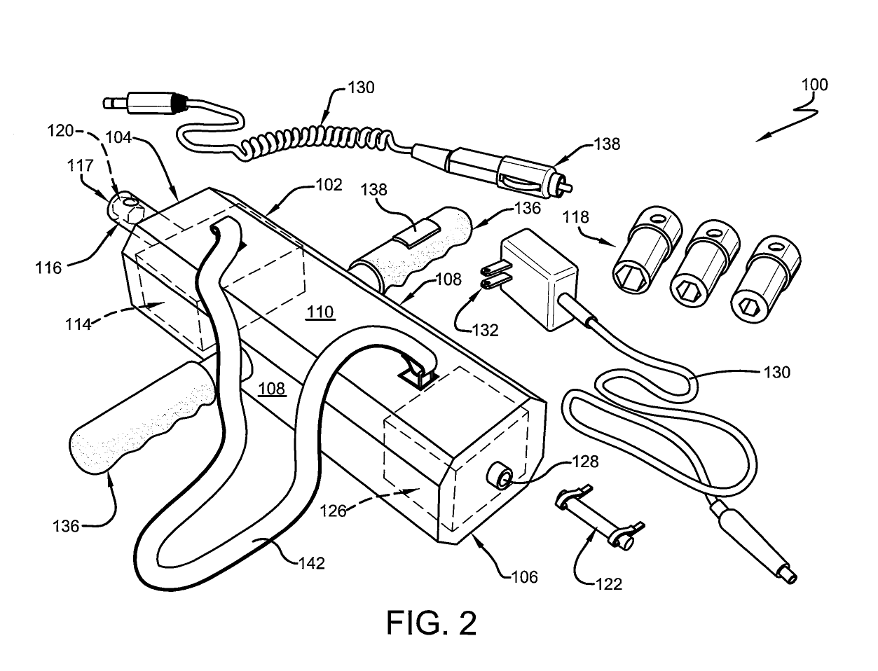

Referring now to FIGS. 2 and 3 a portable power device 100 is illustrated for use in operating the crankshaft of the lifting apparatus 12 in lieu of manually operating the hand crank 20. The portable power device 100 comprises a motor 114 encased within a housing 102. The housing 102 is typically a shell that is metal or plastic in composition, although it is contemplated that the housing may comprise a variety of materials, such as but not limited to polymers, alloys, and the like without affecting the overall scope of the invention. The housing 102 is generally rectangular in configuration comprising a first end 104, a second end 106, opposing sides 108, a top 110, and a bottom 112.

The motor 114 is typically a high-torque electric motor sized to fit within the housing 102. The portable power device 100 further comprises a drive shaft 116 rotatably connected to the motor 114 with an engaging end 117 that extends through the first end 104 of the housing 102. The motor 114 rotates the drive shaft 116 both clockwise and counterclockwise as desired.

The portable power device 100 further comprises a battery 126 encased within the housing 102 and a recharging port 128. The battery 126 is typically a rechargeable battery such as a Nickel Cadmium or Lithium ion battery; however any rechargeable battery as is known in the art may be used as well. The battery 126, once charged, provides the power for operating the motor 114. The recharging port 128 is preferably located within the second end 106 of the housing 102, but may alternatively be located anywhere on the housing 102. The recharging port 128 allows the user to recharge the battery 126 from an external power supply such as a wall outlet. A power cord 130 is connectable to the recharging port 128 and to the external power supply. The power cord 130 may comprise a standard outlet plug 132 or an automobile outlet adaptor 134 that can plug in to a vehicle outlet connected to a vehicle battery, such as a car or truck battery. Alternatively, the portable power device 100 may run directly off of the external power supply through the power cord 130 in the event that the battery 126 is not fully charged.

The drive shaft 116 comprises an opening 120 located within the engaging end 117. The opening 120 is essentially a bore within the engaging end 117 approximately between one and 1¾ inches in diameter. The opening 120 must be large enough to fit over the male drive end 24 of the landing gear 14. Once the opening 120 is in place over the male drive end 24, drive shaft 116 is secured to the male drive end 24 with a securing element 122. The securing element 122 penetrates the drive shaft 116 and the male drive end 24 so that the opening 120 remains in place over the male drive end 24 while the motor 114 is in operation.

The portable power device 100 further comprises at least one engaging element 118 removably attachable to the engaging end 117 of the drive shaft 116. The at least one engaging element 118 is essentially a socket for engaging a lug nut for a vehicle tire. The securing element 122 fits through drive shaft 116 and the engaging element 118 so that the engaging element 118 remains in place over the drive shaft 116 while the motor 114 is in operation. While the securing element 122 is typically a pin, it is contemplated that the securing element 122 may comprise any similar mechanical fastener such as but not limited to a straight pin, a cotter pin, a spring clip, and the like without affecting the overall scope of the invention.

The portable power device 100 further comprises a pair of handle elements 136 extending substantially perpendicularly from the opposing sides 108 of the housing 102. The pair of handle elements 132 allows a user to grip the portable power device 100 and provide stability and leverage for the user to engage the lifting apparatus 12 with the lifting apparatus 12 or the lug nut. A switch element 138 electrically connected to the motor 114 is located on one of the pair of handle elements 132 for engaging and disengaging the motor 114. The switch element 132 is typically a variable speed switch, although any switch allowing the motor 114 to turn on, off, and rotate the drive shaft 116 clockwise and counterclockwise as is known in the art is acceptable.

The portable power device 100 may further comprise a strap element 142 to provide additional stability and leverage for the user. The strap element 142 is attachable to the housing 102 with hooks, rings, bolts, or any other type of fastener known to one of skill in the art.

In a preferred embodiment of the portable power device 100, there are a plurality of interchangeable engaging elements 118, such as a plurality of sockets, attachable to the engaging end 117 of the drive shaft 116. As such, the user may use the portable power device 100 for a variety of rotating applications. For example, the plurality of sockets may fit different sized crankshafts and/or lug nuts. Typically, the crank shaft of landing gear 14 will terminate in the male drive end 24 that the hand crank 20 attaches to and engages. Once the hand crank 20 is removed, the male drive end 24 is exposed and the opening 120 in the drive shaft 116 encapsulates the male drive end 24 to provide the connection. As there are a wide variety of applications, the opening 120 and the plurality of sockets may fit shapes comprising squares, triangles, stars, hexagons, polygons, and the like, or any other shape of existing male drive ends and/or lug nuts known to one of skill in the art.

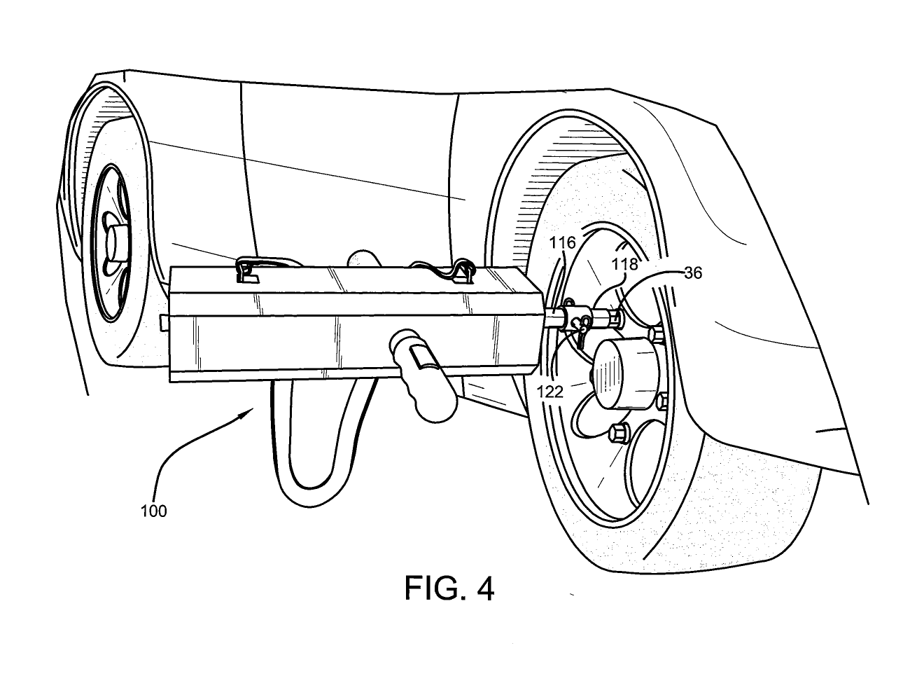

As illustrated in FIG. 4, the portable power device 100 may additionally be used to loosen and/or tighten a lug nut 36 attaching an automobile or vehicle tire 34 to a vehicle. The socket 120 fits over and engages the lug nut 36 without use of the securing element 122. To change the automobile tire 34, the user fits the socket 120 of the appropriate size over the lug nut 36 and engages the motor 114 with the switch element 138 rotating the lug nut 36 off. Once the automobile tire 34 is replaced, the user reverses the direction of rotation on the switch element 138 and tightens the lug nut 36 back in place.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A portable power device for a lifting apparatus comprising:
a housing comprising a first end, a second end, and opposing sides;
a motor encased within the housing;
a drive shaft rotationally connected to the motor extending through the first end of the housing, wherein the drive shaft comprises an opening for engaging a rotatable element of the lifting device; and
a securing element for holding the opening of the drive shaft in position over the rotatable element; and
a pair of handle elements extending from the opposing sides, wherein the second handle element comprises a switch element in electrical communication with the motor.

2. The portable power device of claim 1, wherein the portable power device is utilized to rotate at least one of the following: a lug nut, a rotational mechanical fastener; and a crank shaft.

3. The portable power device of claim 1, further comprising a pin element for securing the opening of the drive shaft in position over the rotatable element.

4. The portable power device of claim 1, wherein the switch element rotates the drive shaft clockwise and counterclockwise.

5. The portable power device of claim 1, further comprising a battery encased within the housing in electrical communication with the motor.

6. The portable power device of claim 1, further comprising a strap element attachable to the housing.

7. A portable power device comprising:
a housing comprising a first end, a second end, opposing sides, a top, and a bottom;
a motor encased within the housing;
a drive shaft rotationally connected to the motor extending through the first end of the housing, wherein the drive shaft comprises an opening for engaging a rotatable element of a lifting apparatus; and
a plurality interchangeable engaging elements each attachable to the drive shaft;
a pin element for securing the drive shaft to the plurality interchangeable engaging elements or to the rotatable element of the lifting apparatus; and
a pair of handle elements extending from the opposing sides, wherein the second handle element comprises a switch element in electrical communication with the motor.

8. The portable power device of claim 7, further comprising a battery encased within the housing in electrical communication with the motor.

9. The portable power device of claim 8, further comprising a recharging port for connecting the battery to a power source.

10. The portable power device of claim 7, wherein the lifting apparatus comprises a landing gear for a semi tractor trailer comprising a male drive end for rotatably operating the landing gear and wherein the opening of the drive shaft fits over the male drive end.

11. The portable power device of claim 7, wherein the plurality interchangeable engaging elements comprise a plurality of sockets.

12. The portable power device of claim 11, wherein the plurality of sockets fit over the following shapes: a square, a triangle, a star, a hexagon, and a polygon.

13. The portable power device of claim 7, wherein the portable power device is utilized to rotate a lug nut.

14. A portable power device comprising:
a housing comprising a first end, a second end, opposing sides, a top, and a bottom;
a motor encased within the housing;
a drive shaft rotationally connected to the motor extending through the first end of the housing, wherein the drive shaft comprises an opening for engaging a rotatable element of a lifting apparatus; and
a plurality of engaging elements attachable to the drive shaft;
a pin element for securing the drive shaft to the plurality interchangeable engaging elements or to the rotatable element of the lifting apparatus; and
a battery encased within the housing in electrical communication with the motor;
a recharging port located within the second end of the housing for connecting the battery to a power source; and
a pair of handle elements extending from the opposing sides, wherein one of the pair of handle elements comprises a switch element in electrical communication with the motor.

15. The portable power device of claim 14, wherein the lifting apparatus is a jack mechanism for a semi trailer landing gear.

16. The portable power device of claim 15, wherein at least one of the plurality of engaging elements couples to a lug nut.

17. The portable power device of claim 14, wherein the switch element rotates the drive shaft clockwise and counterclockwise.

18. The portable power device of claim 14, wherein the power source is a vehicle battery.

19. The portable power device of claim 14, wherein the switch element is a variable speed switch.

20. The portable power device of claim 14, further comprising a strap element attachable to the housing.
